(19) United States
(12) Patent Application Publication
(10) Pub. No.: US 2004/0226439 A1
(43) Pub. Date: Nov. 18, 2004

(54) Integrated PZEV module

(75) Inventors: Michael Heim, Brownstown, MI (US); Ljupco Dimitreivski, Macomb Township, MI (US); Frank Robinson, Canton, MI (US)

Correspondence Address: BRINKS HOFER GILSON & LIONE, POST OFFICE BOX 10395, CHICAGO, IL, 60610, US

(73) Assignee: VISTEON GLOBAL TECHNOLOGIES, INC.

(21) Appl. No.: 10/437,321

(22) Filed: May 13, 2003

(51) Int. Cl. B01D 53/02

(52) U.S. Cl. 95/143

(57) ABSTRACT

An auxiliary fuel vapor adsorption device includes a housing and an activated carbon segment contained within the housing and including a quantity of activated carbon material. A dust separator is also contained within the housing and in fluid communication with the carbon segment, and a canister vent valve is mounted to the housing in fluid communication with the activated carbon segment. The invention allows for the reduction of evaporative emissions by minimizing interconnecting joints between necessary fuel system components.

### BACKGROUND OF THE INVENTION

Increasingly strict emissions legislation is continuing to affect automotive manufacturing on a global scale. In the United States, California's developing LEV (low-emissions vehicle) II and PZEV (partial-zero-emissions vehicle) standards are pushing the envelope for evaporative emissions regulations. These stringent standards are likely to serve as an example for future standards throughout the world.

Present regulations cover both active (tailpipe) emissions when a vehicle is operating and passive (evaporative) emissions from parked vehicles. In internal combustion vehicles, PZEV regulations have been established to become effective in model year 2003 cars. These regulations generally allow total vehicle hydrocarbon emissions of 0.35 g/day. The slightly less-strict LEV II standard allows no more than 0.5 g/day of total hydrocarbons to escape from a parked car.

The fuel system in a vehicle accounts for approximately 30% of the evaporative hydrocarbon emissions from a parked vehicle. It has thus become important to minimize all breaches of the fuel system and its associated venting system to prevent the escape of such emissions to the atmosphere. User-accessible openings into the fuel system are typically protected by tight compression seals, or the openings may be blocked by carbon filters. Other areas of hydrocarbon leakage occur at the joints between various components within the fuel venting system. In particular, the interconnected fuel system components, such as the vent valve, the carbon canister and the dust separator, are typically linked in prior art systems using a plurality of interconnected ducts. Various shortcomings of these component configurations as presently known can lead to several inefficiencies.

For example, the multiple ducts in a venting system must be durable enough to prevent leakage of hydrocarbons, and they are required to be made of materials that are dense and relatively expensive. Furthermore, it is often difficult to automate the interconnection of these devices, especially if some of these devices are fixed on the vehicle rather than on the fuel tank, because such separate componentry prevents the preassembly of certain components prior to installation into the vehicle assembly line. The connection joints in venting circuits of typical prior art fuel systems often are the source of significant head losses, which can seriously degrade venting efficiency and contribute to hydrocarbon leakage. The integrity of the various joints between the ducts may be further compromised if it becomes necessary to allow some of the venting componentry to be replaceable.

Therefore it is desirable to minimize the number of joints in a fuel tank venting system in order to minimize passive hydrocarbon leakage, while still retaining the convenience and economy of replaceable component parts of the venting system.

### BRIEF SUMMARY OF THE INVENTION

The present invention alleviates one or more of the shortcomings described above by providing an integrated module for controlling hydrocarbon emissions from the fuel system of a vehicle. The invention allows for the further reduction of evaporative emissions by minimizing interconnecting joints between necessary fuel system components in order to prevent escape of fuel vapors from the fuel system flowpath.

In one aspect of the present invention, an auxiliary fuel vapor adsorption device includes a housing and an activated carbon segment contained within the housing and including a quantity of activated carbon material. A dust separator is also contained within the housing and in fluid communication with the carbon segment, and a canister vent valve is mounted to the housing in fluid communication with the activated carbon segment.

In another aspect of the present invention, a method is described for controlling hydrocarbon emissions from a vehicle. The method includes the steps of providing a first integrated module including an activated carbon segment, a vent valve assembly and a dust separator. The segment, assembly and separator are at least partially contained within a single one-piece housing. The integrated module is then connected to a carbon canister mounted in the vehicle. After operating the vehicle and perhaps after a significant amount of time, it may become necessary to replace the first integrated module with a second integrated module having similar integrated componentry. The first integrated module is disconnected from the canister in the vehicle and a second integrated module is connected to the canister.

In yet another aspect of the present invention, a replaceable device for reducing hydrocarbon emissions from the fuel system of a vehicle is provided. The device includes a housing defining a fluid pathway therethrough and including means for fluidly connecting the housing to a carbon canister of the vehicle fuel system and an activated carbon segment disposed within the housing and across the fluid pathway. A dust separator is disposed within the housing and fluidly connected to the activated carbon segment and the fluid pathway, and a canister vent valve disposed at least partially within the housing and connected across the fluid pathway. The dust separator, the carbon segment and the canister vent valve components are connected to the fluid pathway within the housing to prevent hydrocarbon leakage from between the components.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF SEVERAL VIEWS OF THE DRAWINGS

FIG. 1 is a perspective view of one embodiment of the apparatus of the present invention installed on a fuel system carbon canister;

FIG. 2 is an exploded perspective view of the embodiment of the integrated PZEV module shown in FIG. 1 integrating a large bleed element;

FIG. 3 is an enlarged perspective view of the exterior of a second embodiment of the integrated PZEV module similar to that of FIG. 1, but integrating a small bleed element; and

FIG. 4 is a perspective view of the integrated PZEV module embodiment of FIG. 3 installed on a fuel system carbon canister.

### DETAILED DESCRIPTION OF THE PREFERRED EMBODIMENTS OF THE INVENTION

In accordance with the present invention, an integrated PZEV module is provided to eliminate hydrocarbon emissions due to connections and fittings. In the module, various components are integrated into a single part which can be attached to currently installed carbon canister designs in order to meet upcoming LEVII and PZEV regulations. The PZEV module embodiments disclosed herein combine an activated carbon element or a small volume of activated carbon as a hydrocarbon migration control device, a canister vent valve and a dust separator to prevent dust contamination of the activated carbon from the outside environment.

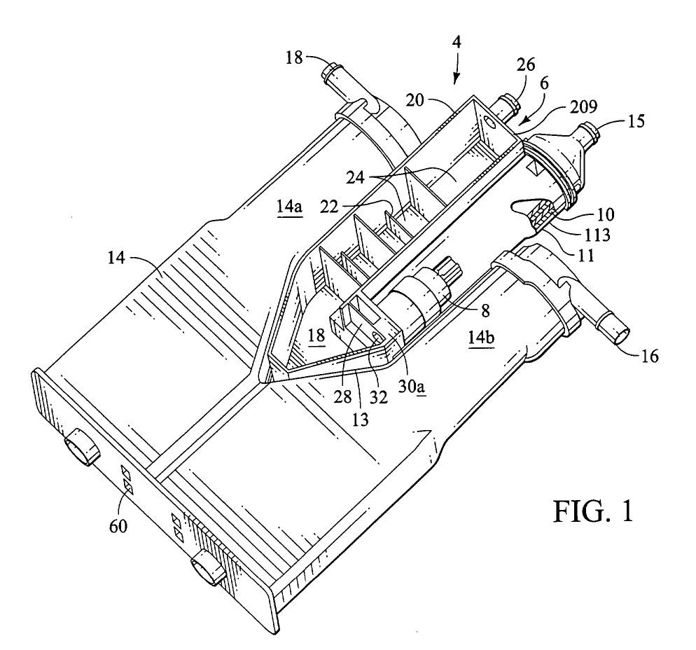

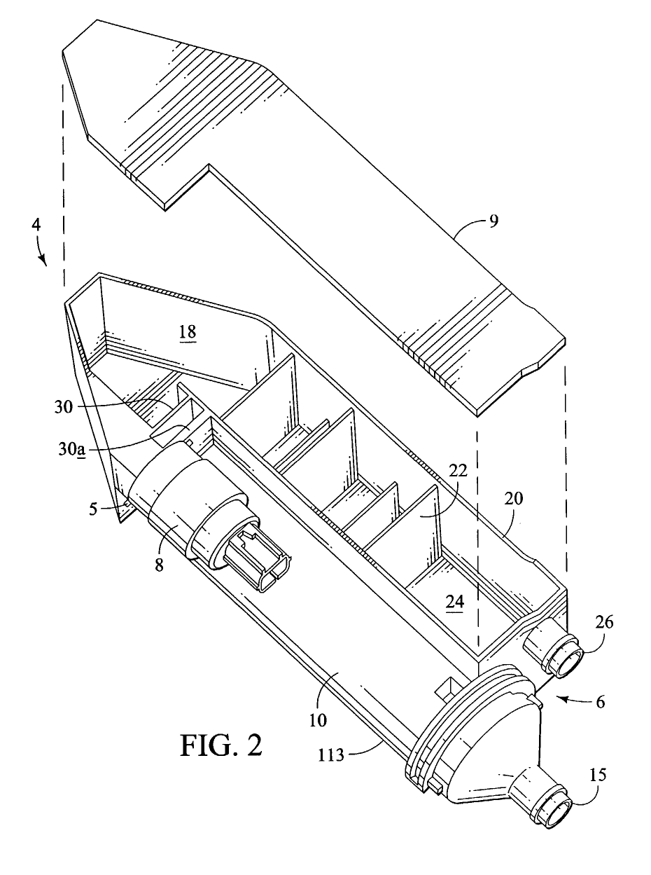

FIGS. 1 and 2 illustrate perspective views of a first embodiment of the PZEV module in accordance with the present invention. As shown in the drawings, a PZEV module 4 is provided having a dust separator component 6, a vent valve component 8, and an activated carbon component 10. The three components are integrated together via a single integrated housing 12. The housing 12 of the module 4 is placed in mechanical and fluid communication with the separate housing of a vehicle carbon canister 14, in particular by fitting the housing 12 within a form-fitted space 13 defined between two protruding portions 14a and 14b of the canister 14. The housing 12 of the PZEV module Y consists of one single molded part. Mounting features 5 are molded in to the module to easily attach the unit to the carbon canister 14.

The carbon canister 14 is of a standard adsorbing type utilized in low-emissions vehicles. As illustrated in conjunction with the preferred embodiment, the canister is of the type manufactured, for example, by Visteon. The internal carbon and honeycomb filter elements may be manufactured by Westvaco or other known manufacturers. The canister 14 includes an inlet 16 and an outlet 18 mounted on the protruding portions 14b and 14a, respectively. These connectors are configured for mounting within a standard fuel venting system in a PZEV vehicle to adsorb evaporative hydrocarbons.

FIG. 2 illustrates the integrated PZEV module 4 of the present invention removed from the canister 14. The module 4 includes the dust separator 6, which is formed at least partially from an external bottom wall 18 and side wall 20 of the housing 12. A plurality of upstanding partition walls 22 and 24 define a plurality of dust chambers 24 within the housing 12 to provide areas for the trapping of dust that may enter with fresh air from outside of the unit.

Fresh air used in the hydrocarbon adsorption process in the main canister 14 is provided to the module through a fresh air inlet 26 formed on an endwall 20a of the separator 6. The fresh air inlet 26 is of a standard configuration for connection to a fresh air ventilator system or air intake (not shown). The set of communicating chambers 24 leads to a larger end chamber 28. An opposing sidewall 30 of the end chamber 28 defines an opening 32 that leads externally from the housing 12.

The flow of fresh air into the interior chambers 24 and the end chamber 28 is controlled by a vehicles purge system, or Vapor Management Valve (“VMV”). A canister vent valve component 8 is mounted to the housing 12 in order to allow for OBD-2 testing of the system. The canister vent valve component 8 is mounted at least partially within the housing 12 to an exterior sidewall 30a, with a portion protruding outwardly therefrom. One or more mounting features 50 may be implemented to securely and removably connect and retain the vent valve component 8, such as through a snap-fit. The use of a removable mounting feature ensures serviceability of the components. Such a mounting feature may include o-rings or various other seals to ensure an airtight interface between the vent valve housing and the rim of the opening 32. The vent valve component 8 includes a solenoid 40 integrated therewith for operating (opening and closing) the vent valve, and the solenoid 40 may be electrically operated via external electrical contacts 42. The contacts 42 reside within a standard electrical connector socket 44 mounted externally from the housing 12, which may be connected to a standard vehicle electrical control system (not shown). The connector socket 44 may also be mated with various emissions testing equipment to ensure closing of the vent valve 8 during OBD-2 testing of the vehicle emission control system.

To further reduce hydrocarbons that may escape through the fresh air inlet 18 the canister 14, an activated carbon segment 10 is interposed into the flowpath through the housing 12. As shown, the housing 12 includes a lower, cylindrical portion 11 that at least partially houses a large bleed element 113. The bleed element 113 contains the carbon segment 10, which is preferably an extruded ceramic honeycomb filter element structure containing an amount of activated carbon and a binder. An end portion of the lower portion 11 of the housing 12 includes a bleed connector 15 that may be connected to vent the system. In the alternative, a carbon segment may be placed between the opposing sidewall 30 and the exterior sidewall 30a of the housing 12, or otherwise fully integrated within the housing.

The chamber portions of the housing 12 are covered by a cover plate 9 (shown in FIG. 2) that may be permanently affixed over the sidewall 20 and endwalls 20a. The cover may be welded in place using sonic welding techniques, or through the use of durable adhesives or other techniques to ensure that there is no hydrocarbon seepage through the seams between the cover 9 and the remainder of the housing 12.

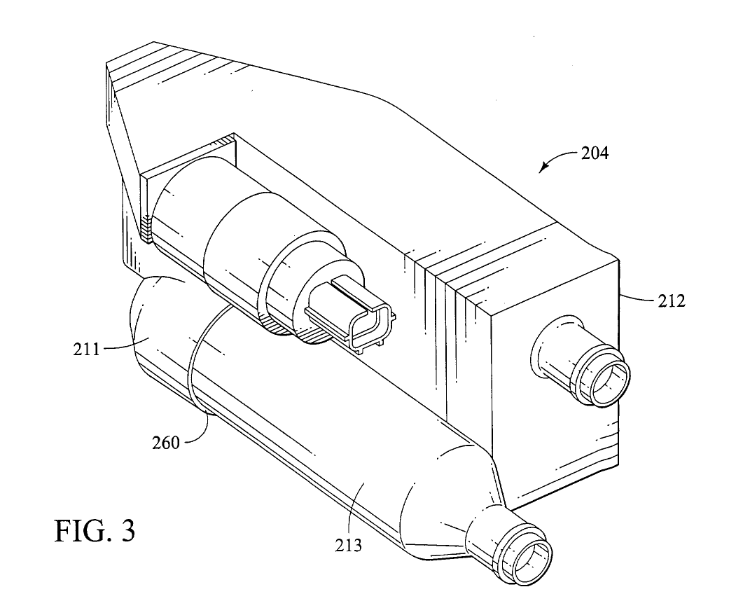

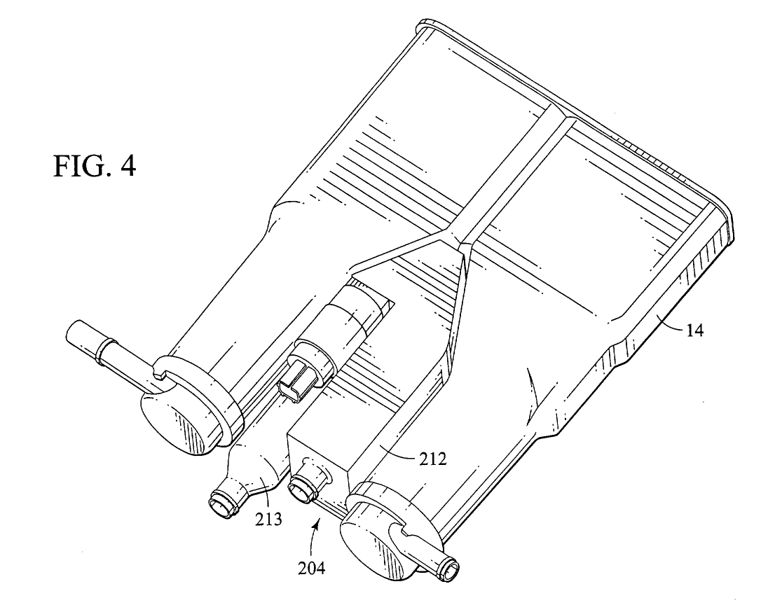

A second embodiment of the PZEV module is depicted in FIGS. 3 and 4. The module 204 is shown with similar componentry, including a housing 212 having a lower portion 211. A small bleed element 213, which, like the large bleed element 113 above, contains an internal carbon segment, is snap fit into a form-fitted opening 260 in the lower housing portion 211. This allows the canister 213 to be easily serviced. The module 204 is shown mounted to the vehicle carbon canister 14.

The PZEV module described herein is a compact, low-cost integrated package that exhibits a low pressure drop to assure that there is no significant impact on onboard refueling vapor recovery (ORVR) and purge of the fuel venting system. Furthermore, the entire PZEV module may be easily replaced by removing the module from its position on the canister and replacing it with a new PZEV module as necessary.

1. An auxiliary fuel vapor adsorption device comprising:
a housing;
an activated carbon segment mounted to said housing and including a quantity of activated carbon material;
a dust separator contained within said housing and in fluid communication with said carbon segment; and
a canister vent valve mounted to said housing and in fluid communication with said activated carbon segment.

2. The device of claim 1 wherein said dust separator is in fluid communication with an air supply for supplying air from an exterior of said automobile.

3. The device of claim 2 further comprising removable attachment means for attaching said canister vent valve to said housing.

4. The device of claim 1 further comprising at least one mounting feature for mounting said device to a carbon canister.

5. The device of claim 1 wherein said activated carbon segment is contained within a bleed element container.

6. The device of claim 1 wherein the housing is a single molded piece.

7. The device of claim 6 wherein said carbon segment is contained within a bleed element, and said dust separator and said bleed element are fused together without any removable joints therebetween.

8. The device of claim 6 wherein said vent valve is connected to said housing and at least partially protruding therefrom.

9. The device of claim 8 wherein said housing completely encloses said dust separator and said carbon segment.

10. The device of claim 1 wherein the interior walls of said housing form at least a portion of said dust separator.

11. The device of claim 1 wherein said housing is integrally molded to said vent valve, said carbon segment and said dust separator.

12. A method of controlling hydrocarbon emissions from a vehicle, said method comprising the steps of:
providing a first integrated module including an activated carbon segment, a vent valve assembly and a dust separator, said segment, assembly and separator being at least partially contained within a single one-piece housing;
connecting said first integrated module to a carbon canister mounted in said vehicle;
operating said vehicle;
disconnecting said first integrated module from said carbon canister;
providing a second integrated module including an activated carbon segment, a vent valve assembly and a dust separator, said segment, assembly and separator being at least partially contained within a single one-piece housing; and
connecting said second integrated module to said carbon canister.

13. The method of claim 12 wherein said one-piece housing of said first integrated module includes a cover plate mounted to said housing.

14. The method of claim 12 wherein the step of connecting said first integrated module further comprises mounting said module to at least one mounting feature of said module.

15. The method of claim 12 further comprising the step of removing said first integrated module from said vehicle after operating said vehicle and inspecting said module.

16. A replaceable device for reducing hydrocarbon emissions from the fuel system of a vehicle, said device comprising:
a housing defining a fluid pathway therethrough and including means for fluidly connecting said housing to a carbon canister of said vehicle fuel system;
an activated carbon segment disposed within said housing and across said fluid pathway;
a dust separator disposed within said housing and fluidly connected to said activated carbon segment and said fluid pathway; and
a canister vent valve disposed at least partially within said housing and connected across said fluid pathway,
wherein said dust separator, said carbon segment and said canister vent valve components are connected to said fluid pathway within said housing to prevent hydrocarbon leakage from between said components.

17. The device of claim 16 wherein only a fluid inlet and outlet for said fluid pathway are defined in said housing.

18. The device of claim 17 wherein said dust separator and said vent valve are nonremovably mounted within said housing.

19. The device of claim 17 wherein said fluid pathway further comprises internal ductwork within said housing to allow interconnection between said components.

20. The device of claim 19 wherein said housing is a single blow-molded piece.
